(19) United States
(12) Patent Application Publication
(10) Pub. No.: US 2007/0258793 A1
(43) Pub. Date: Nov. 8, 2007

(54) Magazine for housing screws

(76) Inventor: Fred Sundstrom, Gallo (SE)

Correspondence Address: YOUNG & THOMPSON, 745 SOUTH 23RD STREET, 2ND FLOOR, ARLINGTON, VA, 22202, US

(21) Appl. No.: 11/639,281

(22) Filed: Dec. 15, 2006

(30) Foreign Application Priority Data
May 5, 2006 (SE) 0601002-9

(51) Int. Cl. F16B 15/08

(52) U.S. Cl. 411/442; 425/542

(57) ABSTRACT

A magazine for screws includes seats defined by walls connecting longitudinally an insert end with an exit end of the seats, wherein in at least one seat a screw having a shank connecting a screw-head directed towards the insert end to a screw-tip directed towards the exit end, the screw-head having a first radius and the shank a second radius smaller, is housed, than the first radius, the at least one seat being formed internally with at least one wing-member running longitudinally from near the insert end towards the exit end, the at least one wing extending from a wing-root connected to the seat wall to a wing-tip projecting into the seat. In any arbitrary plane intersecting the wing and seat transversally to the longitudinal, the extension of the at least one wing from wing-root to wing-tip radially overlaps the radius of the screw-head, and the at least one wing is flexible from the wing-root towards the wing-tip.

### TECHNICAL FIELD OF THE INVENTION

The present invention relates to a magazine comprising seat-defining walls connecting an insert end with an exit end of the seats, and from which screws loaded into the seats via the insert end can be driven out via the exit end by means of a rotating tool.

### BACKGROUND AND PRIOR ART

Screw-magazines for this purpose are previously known, such as the screw-magazine disclosed in EP 1 212 539 granted to the inventor of the present invention. The magazine of EP 1 212 539 comprises rows of screw-seats defined and separated through demolishable walls engaged by the heads of screws loaded into the magazine, and deformed thereby upon driving out the screws. In result of the seat walls being deformed, this magazine is typically loaded with screws in each second row only, required in order to ensure that remaining screws are accurately arrested between intact seat-walls in the magazine. Though advantageous in many aspects, such as low price, low weight and ease of handling, this known magazine suffers from poor utilization of space, e.g.

Another previously known magazine for screws is the screw-package disclosed in U.S. Pat. No. 3,812,961 for Merrick et al. This screw-package comprises circular screw-seats interconnected in a singular row. Each seat houses a screw, the head of which upon driving out the screw is guided from strips running longitudinally along the cylindrical seat wall from an insert end towards an exit end of the seat. About midways between insert and exit ends, the strips separate from the seat wall and form fingers reaching radially into the seat so as to engage the screw's shank with the flexing free ends of the strips. The prime object of the strips is to center the screw while reducing friction between the seat wall and the rotating screw head upon driving out. Thus, upon driving out the screw, the periphery of the screw-head is guided in sliding contact with a radially inner surface of the strip, for which reason the radial extension of the strip needs to be shallow. The radial extension of the strip is far less than a circumferential width thereof, as viewed in a sectional plane through seat and strip transversally to the longitudinal, resulting in a rigid strip structure that may be formed alternatively as a relief in the seat wall. Accordingly, the inner radius and radial extension of the strips need to be closely adapted to the radius of a screw head, requiring accurate production, minute tolerances and discriminating use of the seat/screw package for housing screws but of one diameter size.

### SUMMARY OF THE INVENTION

The present invention aims to provide an improved magazine for screws. One object of the invention is to provide a screw-magazine with a capacity to hold screws of more sizes than one, another object is to provide a screw-magazine that is repeatedly loadable with screws into its seats, and still another object is to provide a screw-magazine which is adapted to be loaded in an automated procedure.

One or several of these objects are met in a magazine for screws as specified in the claims, the subordinate ones thereof defining advantageous embodiments of the invention as specified in independent claims.

Briefly, the present invention discloses a magazine comprising seat-defining walls connecting an insert end with an exit end of the seat, wherein each seat is formed internally with at least one wing-member running longitudinally from near the insert end towards the exit end, said at least one wing extending from a wing-root connected to the seat wall to a wing-tip projecting into the seat. The magazine is characterized in that in any arbitrary plane intersecting the seat and wing transversally to the longitudinal, the extension of said at least one wing from wing-root to wing-tip is greater than a width dimension of the wing-root in the sectional plane, and in that said at least one wing is flexible from the wing-root towards the wing-tip in the sectional plane.

In other words, a magazine for screws according to the present invention comprises seat-defining walls connecting an insert end with an exit end of the seat, wherein in at least one seat a screw is housed, the screw having a shank connecting a screw-head directed towards the insert end with a screw-tip directed towards the extend, the screw-head having a first radius and the shank having a second radius lesser than said first radius, wherein the at least one seat being formed internally with at least one wing-member running longitudinally from near tile insert end towards the exit end, said at least one wing extending from a wing-root connected to the seat wall to a wing-tip projecting into tile seat, characterized in that in any arbitrary plane intersecting the wing and seat transversally to the longitudinal, the extension of said at least one wing from wing-root to wing-tip radially overlaps the radius of said screw-head, and in that said at least one wing is flexible from the wing-root towards the wing-tip in the sectional plane.

The at least one wing's extension from wing-root to wing-tip preferably results in a radial overlap amounting to approximately 5-70% of the radius of the largest diameter sized screw-head receivable into the seat, the periphery of which touches the seat-walls. Preferably though, the wing's extension does not overlap the radius of said shank in the sectional plane.

Also preferably, the at least one wing is elastically flexible from the wing-root towards the wing-tip in the sectional plane.

Advantageously, two or more wings are provided to project into the seat at equal angular spacing in the sectional plane.

Embodiments include a variant having a seat of polygonal section wherein the wing-root of the at least one wing connects to a corner of the seat. Another embodiment comprises a seat of polygonal section wherein the wing-root of the at least one wing connects to a wall of the seat.

In yet another and preferred embodiment, the seat has a quadrangular section and wings projecting into the seat from each wall of the seat. In this embodiment, wings of adjacent seats may be arranged to run in parallel on separate sides of a seat-separating wall, and mutually laterally spaced in the plane of the wall. In quadrangular embodiments having seat sides of equal lateral dimension or width in the sectional plane, all wings in a seat may be arranged to run equally laterally displaced from a longitudinal centre of the associated seat wall, as viewed in a circumferential direction of the seat. In a screw-magazine containing two or more parallel rows of screw-housing seats, the wings of all seats preferably are uniformly displaced from the longitudinal centers of associated seat-separating walls in the circumferential direction of the seats.

Also, the walls separating the seats may be resilient. Thus, in a magazine comprising a rectangular matrix formed by at least two parallel rows of quadrangular seats separated by resilient walls, wherein all seats comprises wings uniformly displaced from the longitudinal centers of associated seat-separating walls in the circumferential direction of the seats, the seat-separating walls will undergo a uniform deformation upon driving out screws from the seats. In effect of resilient seat walls, additional flexibility is provided to the wings flexing in the rotary direction of a screw being driven out from the seat. Through this measure, not only allowing a compact structure, the wings are also spared from rupture or dislocation allowing the magazine to be repeatedly loaded with screws. This aspect of the magazine is further supported when the wings are made elastically flexible in said sectional plane.

A magazine for screws according to the invention is advantageously produced from a plastic material suitable for injection molding. In a region near the insert end, the wing's extension from wing-root to wing-tip may be reducing towards the insert end of the magazine, this way simplifying insertion of screws into the seats via the insert end. Near the exit end, the at least one wing may be arranged so as to connect to a tongue projecting angularly from the associated wall into the seat and sloping towards the exit end, the tongue being flexible in a longitudinal plane through the seat, and operative to center and guide the screw shank upon driving out the screw.

### SHORT DESCRIPTION OF THE DRAWINGS

The invention is more closely described below in relation to accompanying diagrammatic drawings, illustrating practicable examples of the invention. In the drawings,

FIG. 1 is a perspective view showing a first embodiment of a magazine for screws according to the present invention;

FIG. 2 is a top view of the magazine of FIG. 1;

FIG. 3 is a section through the magazine of FIGS. 1 and 2, illustrating a longitudinal plane III-III of FIG. 2;

FIG. 4 is a longitudinal section corresponding to FIG. 3, showing another embodiment of the magazine shown in FIGS. 1-3;

FIG. 5 is a section through the magazine of FIG. 2 illustrating an arbitrary sectional plane V-V transversally to the longitudinal;

FIGS. 6a and 6b are transverse sectional views corresponding to FIG. 5, diagrammatically illustrating different embodiments of the invention, and

FIG. 7 is a transverse sectional view illustrating a most advantageous embodiment of the invention.

### DETAILED DESCRIPTION OF THE INVENTION

With reference to the drawings 1-4, a magazine 1 for housing screws according to the present invention comprises seats 2 that are defined and separated through seat walls 3, running in a longitudinal direction of the seats and connecting an insert end 4 with an exit end 5 of the seats and magazine. Multiple seats 2 may be combined into a geometric matrix comprising one or several rows of seats providing a box from which screws 6 housed in the seats may be driven out by the use of a rotating tool, such as a bit tool driven by a screw driver. The seats may be arranged in two or more parallel rows as shown in the drawings, or in any other useful geometric configuration as desired. Preferably, the exit end of the magazine is planar and runs rectilinearly to the longitudinal axes of the seats, this way providing a firm and guiding support against a surface and ensuring an angularly accurate driving in of the screws.

The seat 2 is structured, as will be further explained below, to receive and hold a screw 6 comprising a shank 7 connecting a screw-head 8 with a screw-tip 9. The screw 6 is insertable into the seat via the insert end 1 to be sealed with its head near the insert end while the tip thereof is directed towards the exit end 5, from which the screw exits upon being driven out while rotated in the effective rotary direction of its threaded shank.

While seated in the seat, the screw 6 is arrested through at least one wing-member 10 engaging the screw's head 8. The wing/wings 10 run longitudinally from near the insert end 4 towards the exit end 5 of each screw-housing seat 2.

As is more readily apparent from the partially broken away sectional view of FIG. 5a, the wing 10 extends radially into the seat from a wing-root 11, connecting to the seat wall 3, to a wing-tip 12 projecting into the seat. More precisely, in any arbitrary plane intersecting the seat and wing transversally to the longitudinal, the radial extension rW of the wing 10 from wing-root to wing-tip is greater than a width dimension w of the wing-root as viewed in a circumferential direction of the seat. In fact, the extension of the wing 10 from wing-root to wing-tip is such that the wing, by its tip end, radially overlaps a first radius r1 of said screw-head 8. The extent of overlap may amount to about 5-70% of the radius of the widest screw-head receivable into the seat, the periphery of which touches the seat walls as illustrated in FIG. 7. Nevertheless, the amount of overlap does not need to be critically determined in relation to a specific screw: in effect of the overlapping radii, screws of different diameter sizes are effectively arrested in the seat as long as the wing-tip engages the periphery of the screw-head. In result hereof, a magazine according to the present invention is useful in combination with screws of different sizes, diagrammatically illustrated in FIG. 5 through the differently diameter sized screw-heads.

Preferably though, the radial extension rW of the wing 10 does not however overlap a second radius r2 of the screw-shank 7 which is lesser than the first radius r1, even if this condition is not critical or required for the intended operation of the wing.

In effect of the overlapping condition, the wing-tip is displaced by the screw-head 8 upon driving out a screw from the seat. For this purpose, the wing 10 is made flexible from the wing-root towards the wing-tip in any arbitrary plane intersecting the seat and wing transversally to the longitudinal. As illustrated in FIG. 5, the wing is flexible in the sectional plane so as to bend in the rotary direction R of a screw upon, driving out the screw from the seat via the exit end.

Preferably, the wing 10 is made elastically flexible in the transverse plane, the wing-tip thereby successively returning to the original non-flexed position behind the moving screw-head being driven out under rotation. This measure is advantageous while allowing repeated use of the magazine, since the wing returns to a position where it is capable of arresting a second screw inserted into the seat.

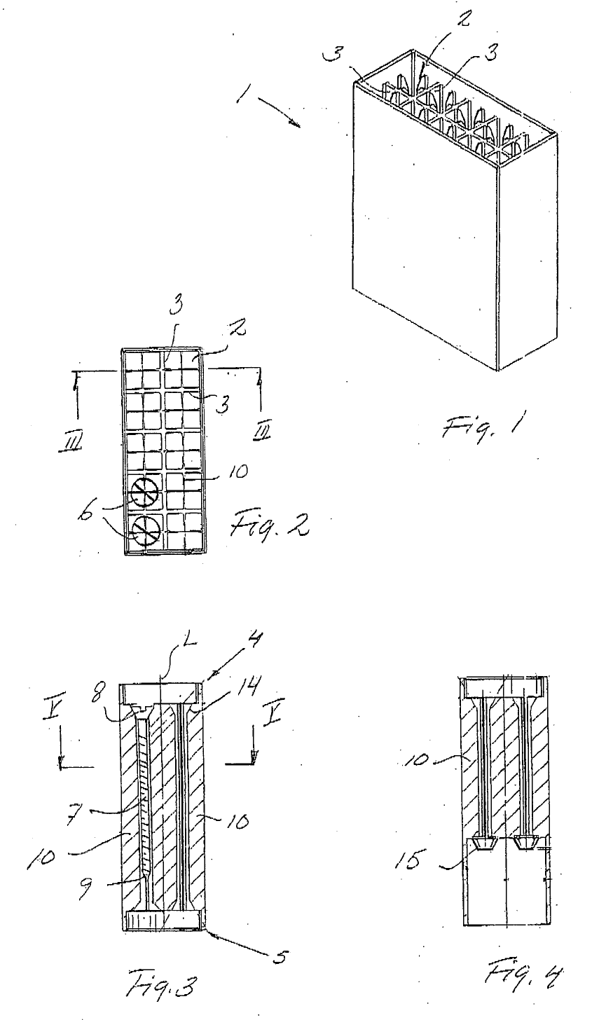

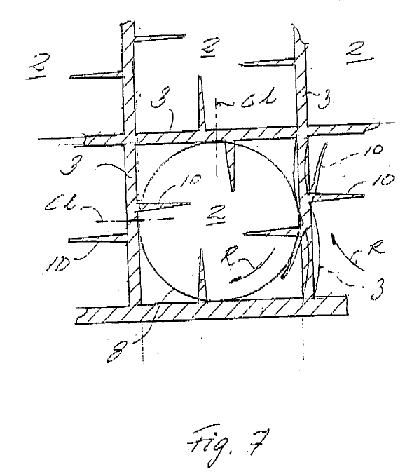

A magazine incorporating the wing-member 10 may be realized in several embodiments having different geometries with respect to the sectional shape of the seats, and with respect to the combination of seats into a matrix. For example, the invention may be realized through circular seats internally formed with at least one flexible wing 10 as described above, overlapping the screw-head periphery by the wing-tip thereof. Preferably though, each seat comprises two or more wings arranged at equal angular spacing in the sectional plane, by which the screw is not only retained in the seat, but also centered by an equally distributed contact from the wing-tips upon being driven out from the seat. More preferred embodiments comprise seats of polygonal section having wings connecting, by the wing-roots thereof, to corners of the seat or to the seat walls extending laterally between the seat corners in the sectional plane. Eleven more preferred polygonal embodiments comprise seats having wings extending into the seat from each or from each second side wall of the seat, at equal angular spacing in the sectional plane. Polygonal embodiments may include, e.g., seats of triangular section as illustrated in FIG. 6a or seats of hexagonal section as illustrated in FIG. 6b. Among the most preferred embodiments is the magazine having seats of quadrangular or square section, i,e. a quadrangular seat in which all seat walls are of equal lateral dimension, and wherein wings 10 extend from each wall of the seat as illustrated in FIGS. 1-5 and in FIG. 7.

A most advantageous quadrangular embodiment is disclosed and illustrated in FIG. 7. Like in all polygonal embodiments, FIG. 7 illustrates a specific advantage which is achievable when all wings 10 in a seat run equally laterally displaced from a longitudinal centre C1 of the associated wall of the seat, as viewed in a circumferential direction R of the seat. That is, when wings 10 are laterally displaced from the centers C1 in the rotational direction R of a screw housed in the seat, the wing-tips are caused by the screw-head periphery to flex towards the near seat-corners in the direction of rotation upon driving out the screw. Naturally, in connection with counter-rotating screws, the wings may be laterally displaced to the opposite side from the seat wall centers than that disclosed in drawings.

This structural measure permits the polygonal seat to receive a screw, the head 8 of which has a radius that touches the seat walls at their longitudinal centers C1 while still not causing disintegration of the wings when the screw-head is driven out from the magazine. This way, accessible storing space may be used to its maximum.

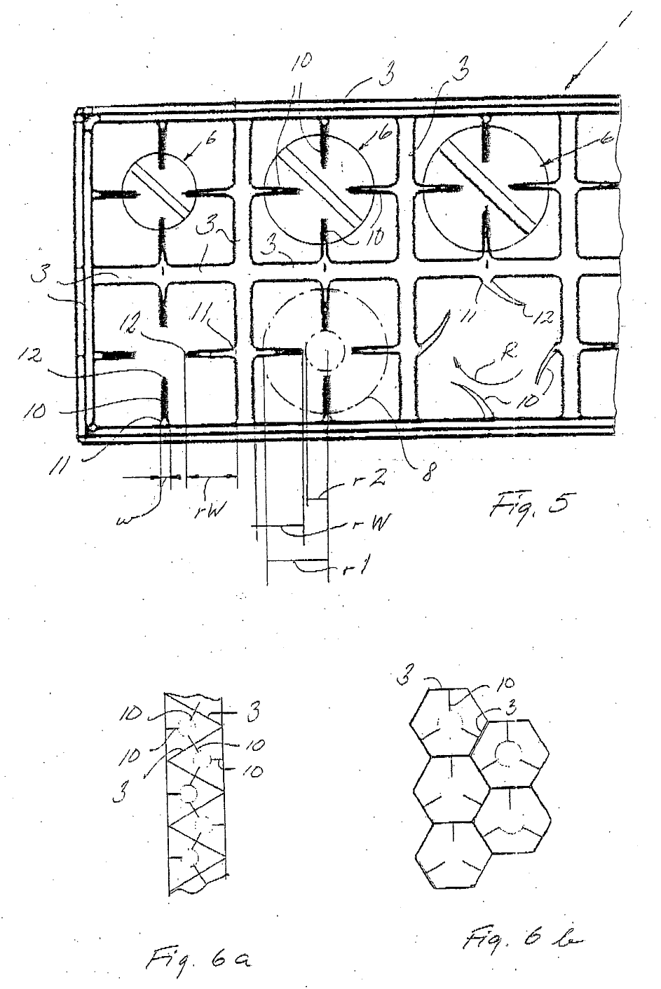

In the embodiment of FIG. 7, wings 10 of adjacent seats 2 run in parallel on separate sides of a seat-separating wall 3, and mutually laterally spaced in the plane of the wall. A further advantage is achievable in magazines having resilient seat-separating walls 3 defining seats of polygonal section, and wherein all seats comprises wings 10 that are uniformly displaced from the longitudinal centers C1 of the associated seat-separating walls, as viewed in the circumferential direction R of the seats. In result of these structural measures, the seat-separating walls will undergo a uniform deformation upon driving out screws from then seats, in FIG. 7 illustrated by dashed lines showing slightly deformed or S-shaped, resilient walls 3 and wings 10 flexing towards the seat corners. The resilient seat walls and relative location of wings thus provide in combination additional flexibility to the wings in the transverse sectional plane. This not only allows a compact structure, but wings are also spared from rupture or dislocation allowing the magazine to be repeatedly loaded with screws. This aspect of the magazine is further supported when the wings are made elastically flexible in said sectional plane, as previously mentioned. Loading the seats with screws, and reloading if desired, is possible through an automated procedure wherein screws are individually inserted into the seats from the insert end of the magazine. Insertion of the screw may be assisted if, in a region near the insert end, the wing's extension from wing-root to wing-tip is reducing towards the insert end of the magazine, creating a widened mouth at the insert end by which the screw's tip and shank are guided for a correct alignment with the seat. A chamfer 14 as illustrated in FIG. 3 may be formed at the insert end of the wing, amounting to, e.g. 30-60° from the longitudinal L. The loading procedure is completed by applying a pressure to the screw-heads, pressing the screws further into the seats until the screw-head periphery is engaged by the wing-tips.

The magazine of the present invention is producable through injection molding of a plastic material, such as a polymer or copolymer that sets into a matrix hating flexible and preferably also elastic properties. A material transparent to light is advantageous. Through the molding process, additional features may be incorporated in the design of the magazine and seats. One example of such modification to the embodiments disclosed above is a wing that connects, near the exit end, to a tongue 15 (see FIG. 4) projecting from the associated wall into the seat and sloping towards the exit end, the tongue being flexible in a longitudinal plane through the seat and effective for centering the screw-shank upon driving out the screw. Other modifications may include a rigid outer wall enclosing the seats, wherein additional rigidity is achievable through corresponding sizing of the wall thickness, e.g. Still another possible modification involves weaknesses incorporated in the outer wall and through which partial sections of the magazine are separable from the rest of the magazine. Another modification may include material savings by forming longitudinal sections of the magazine at insert or/and exit ends wherein seats and/or wings are not provided, e.g.

It will be appreciated by a person skilled in the art, that these aid other features mentioned above may each add, separately or m different combinations, to the solution defined in independent claims.

1. A magazine for screws comprising seats (2) defined by walls (3) connecting longitudinally an insert end (4) with an exit end (5) of the seats, wherein each seat is formed internally with at least one wing-member (10) running longitudinally from near the insert end towards the exit end, said at least one wing (10) extending from a wing-root (11) connected to the seat wall to a wing-tip (12) projecting into the seat, characterized in that in any arbitrary plane intersecting the seat (2) and wing (10) transversally to the longitudinal (L), the extension (rW) of said at least one wing from wing-root (11) to wing-tip (12) is greater than a width dimension (w) of the wing-root in the sectional plane, and in that said at least one wing is flexible from the wing-root towards the wing-tip in the sectional plane.

2. The magazine of claim 1, wherein the at least one wing is elastically flexible from the wing-root towards the wing-tip in the sectional plane.

3. The magazine of claim 1, wherein two or more wings are provided to project into the seat at equal angular spacing in the sectional plane.

4. The magazine of claim 1, wherein the seat has a polygonal section and the wing-root of the at least one wing connects to a corner of the seat.

5. The magazine of claim 1, wherein the seat has a polygonal section and the wing-root of the at least one wing connects to a wall of the seat.

6. The magazine of claim 5, wherein the seat has a quadrangular section, and wings projecting into the seat from each wall of the seat.

7. The magazine of claim 5, wherein wings of adjacent seats run in parallel on separate sides of a seat-separating wall, and mutually laterally spaced in the plane of the wall.

8. The magazine of claim 7, wherein all wings in a seat run equally laterally displaced from the centers (C1) of the associated walls of the seat, as viewed in a circumferential direction of the seat.

9. The magazine of claim 8, wherein all seats of the magazine comprise wings uniformly displaced from the centers (C1) of associated walls of the seats, as viewed in a circumferential direction of the seats.

10. The magazine of claim 1, wherein in a region near the insert end, the wing's extension from wing-root to wing-tip is reducing towards the insert end of the seat.

11. The magazine of claim 1, wherein the wing near the exit end connects to a tongue (15) projecting angularly from the associated wall into the seat and sloping towards the exit end, the tongue being flexible in a longitudinal plane through the seat.

12. The magazine of claim 1, wherein the seat-defining wall is resilient.

13. The magazine of claim 1, produced by injection, casting of a plastic material.

14. A magazine for screws comprising seats (2) defined by walls (3) connecting longitudinally an insert end (4) with an exit end (5) of the seat, wherein in at least one seat a screw (6) is housed, the screw having a shank (7) connecting a screw-head (8) directed towards the insert end to a screw-tip (9) directed towards the exit end, the screw-head having a first radius (r1) and the shank having a second radius (r2) lesser than said first radius, wherein the at least one seat being formed internally with at least one wing-member (10) running longitudinally from near the insert end towards the exit end, said at least one wing extending from a wing-root (11) connected to the seat wall to a wing-tip (12) projecting into the seat, characterized in that in any arbitrary plane intersecting the wing and seat transversally to the longitudinal (L), the extension (rW) of said at least one wing (10) from wing-root (11) to wing-tip (12) radially overlaps the radius (r1) of said screw-head, and in that said at least one wing is flexible from the wing-root towards the wing-tip in the sectional plane.

15. The magazine of claim 14, wherein the extension (rW) of said at least one wing (10) from wing-root (11) to wing-tip (12) radially overlaps the radius (r1) of said screw-head and not the radius (r2) of said shank in said sectional plane.

16. The magazine of claim 14, wherein the wing's extension (rW) from wing-root to wing-tip amounts to 5-70% of the radius (r1) of a screw-head, the periphery of which touches the seat walls.

17. The magazine of claim 14, comprising a rectangular matrix formed through at least two rows of seats (2) of quadrangular section separated by resilient walls (3), each seat comprising wings (10) uniformly displaced from the longitudinal centers (C1) of the associated seat-separating walls as viewed in a circumferential direction of the seats, in result of which the seat-separating walls are uniformly deformable upon driving out screws under rotation in the circumferential direction.

18. The magazine of claim 14, comprising elastically flexible wings in result of which the magazine is adapted to be repeatedly loaded with screws.

19. The magazine of claim 2, wherein two or more wings are provided to project into the seat at equal angular spacing in the sectional plane.

20. The magazine of claim 6, wherein wings of adjacent seats run in parallel on separate sides of a seat-separating wall, and mutually laterally spaced in the plane of the wall.
